(19) United States
(12) Patent Application Publication
(10) Pub. No.: US 2016/0181772 A1
(43) Pub. Date: Jun. 23, 2016

(54) Wire Treatment Pliers Set

(71) Applicant: Hanlong Industrial Co., Ltd., New Taipei City (TW)

(72) Inventors: Chien-Chou Liao, New Taipei City (TW); Mei-Fang Lin, New Taipei City (TW)

(21) Appl. No.: 14/598,266

(22) Filed: Jan. 16, 2015

(30) Foreign Application Priority Data
Dec. 22, 2014 (TW) 103222623

(51) Int. Cl. H02G 1/12; H01R 43/033

(52) U.S. Cl. CPC H02G 1/1214; H01R 43/033

(57) ABSTRACT

A wire treatment pliers set includes a first clamp body and a second clamp body. The first clamp body includes a first main body, a first winding part and at least one first stripping notch. The at least one first stripping notch is located on the first main body. The second clamp body is pivotally connected to the first clamp body. The second clamp body includes a second main body, a second winding part, and at least one second stripping notch. A position of the second winding part corresponds to the first winding part. The at least one second stripping notch is located on the second main body, and a position of the at least one second stripping notch corresponds to the at least one first stripping notch.

### BACKGROUND OF THE INVENTION

1. Field of the Invention

The present invention relates to a wire treatment pliers set; more particularly, the present invention relates to a wire treatment pliers set with many kinds of wire processing functions.

2. Description of the Related Art

In the modern home environment, people may use many kinds of electric appliances, such as a television, an electric light, a telephone, etc., to increase the convenience and comfort of daily life. Those electric appliances usually have a wire or a signal cable to obtain power from an outside power source or to obtain a signal for the electric appliances to present corresponding audio or video. Because wires and signal cables differ in size and specifications, and the electric appliances may need to be connected with wires or signal cables of different lengths to be placed in different positions, the user needs to use different kinds of tools to process different kinds of wires or signal cables such that the electric appliances can be connected with a wire of suitable length and specifications.

When processing the wire, the user usually uses a pair of wire winding pliers and a pair of wire stripping pliers to wind and strip the wire. However, the different wires must be processed by tools having different specifications, and the different types of processing must be executed with different tools. Therefore, the user usually needs to buy multiple tools of the corresponding specifications to meet the requirements of each process and each wire; however, it costs a lot of money for the user to buy tools of different specifications, and it is inconvenient to carry and store many tools.

Therefore, there is a need to provide a new wire processing tool which combines multiple wire processing functions to achieve the feature of convenience.

### SUMMARY OF THE INVENTION

It is an object of the present invention to provide a wire treatment pliers set having multiple wire processing functions to achieve the feature of convenience.

To achieve the abovementioned object, the wire treatment pliers set of the present invention include a first clamp body and a second clamp body. The first clamp body includes a first main body, a first winding part, and at least one first stripping notch. The at least one first stripping notch is located on the first main body. The second clamp body is pivotally connected to the first clamp body. The second clamp body includes a second main body, a second winding part, and at least one second stripping notch. A position of the second winding part corresponds to the first winding part. The at least one second stripping notch is located on the second main body, and a position of the at least one second stripping notch corresponds to the at least one first stripping notch.

According to one embodiment of the present invention, the first clamp body further includes a first blade, the second clamp body further includes a second blade, and a position of the first blade corresponds to the second blade.

According to one embodiment of the present invention, the first winding part further includes a plurality of first winding cylinders. Each of the first winding cylinders respectively has a round face diameter, and the round face diameters of each of the first winding cylinders are different. Any two of the plurality of first winding cylinders are connected to each other in a decreasing order of size of the round face diameter.

According to one embodiment of the present invention, the first winding part further includes a plurality of marks, and the plurality of marks are respectively located on the plurality of first winding cylinders.

According to one embodiment of the present invention, the centers of each of the plurality of first winding cylinders are on a same axis.

According to one embodiment of the present invention, the second winding part is a cone.

According to one embodiment of the present invention, the second winding part further includes a plurality of second winding cylinders. Each of the plurality of second winding cylinders respectively has a round face diameter, and the round face diameters of each of the plurality of second winding cylinders are different. Any two of the plurality of second winding cylinders are connected to each other in a decreasing order of size of the round face diameter.

According to one embodiment of the present invention, the centers of each of the second winding cylinders are on a same axis.

According to one embodiment of the present invention, the first clamp body further includes a first fastening part. The first fastening part is connected to the first winding part and fastened to the first main body. The second clamp body further includes a second fastening part. The second fastening part is connected to the second winding part and fastened to the second main body.

### BRIEF DESCRIPTION OF THE DRAWINGS

FIG. 1 illustrates an exploded perspective view of the wire treatment pliers set in the first embodiment of the present invention.

FIG. 2 illustrates a schematic drawing of the wire treatment pliers set in a closed state in the first embodiment of the present invention.

FIG. 3 illustrates a schematic drawing of the wire treatment pliers set in an open state in the first embodiment of the present invention.

FIG. 4 illustrates a partial schematic drawing of the wire treatment pliers set in the first embodiment of the present invention.

FIG. 5 illustrates a schematic drawing of the first winding part and the second winding part in the first embodiment of the present invention.

FIG. 6 illustrates a schematic drawing of the wire treatment pliers set of the first embodiment of the present invention cutting the wire

FIG. 7 illustrates a schematic drawing of the wire treatment pliers set of the first embodiment of the present invention stripping the insulation layer of the wire.

FIG. 8 illustrates a schematic drawing of the wire treatment pliers set of the first embodiment of the present invention winding the wire.

FIG. 9 illustrates a partial schematic drawing of the wire treatment pliers set in the second embodiment of the present invention.

FIG. 10 illustrates a partial schematic drawing of the wire treatment pliers set in the third embodiment of the present invention.

FIG. 11 illustrates a partial schematic drawing of the wire treatment pliers set in the fourth embodiment of the present invention.

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

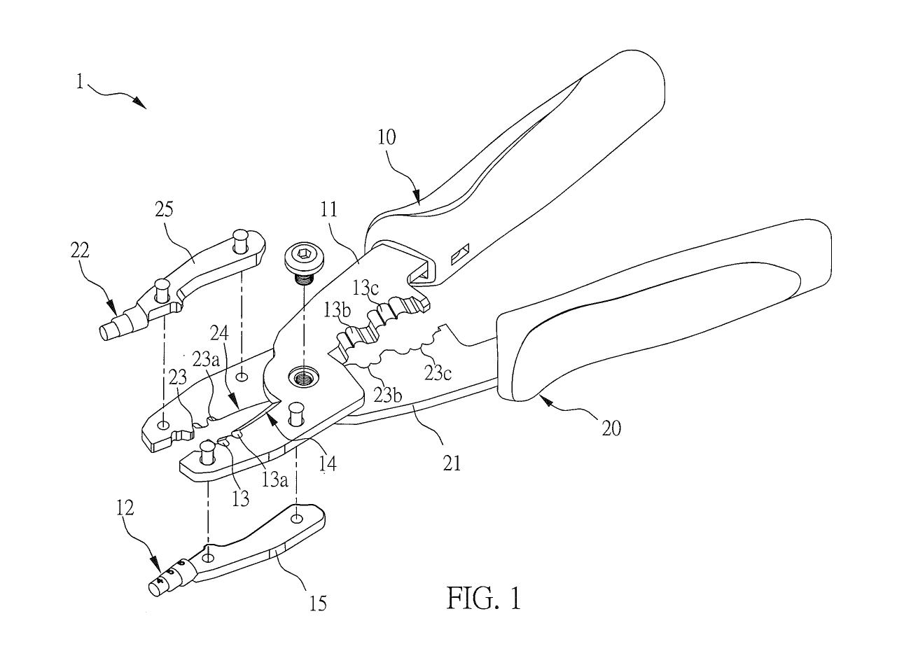

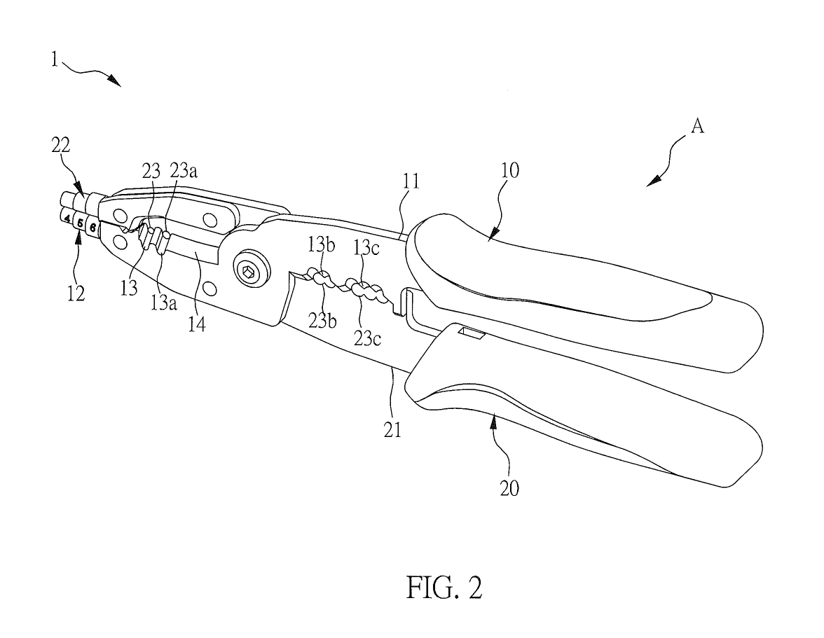

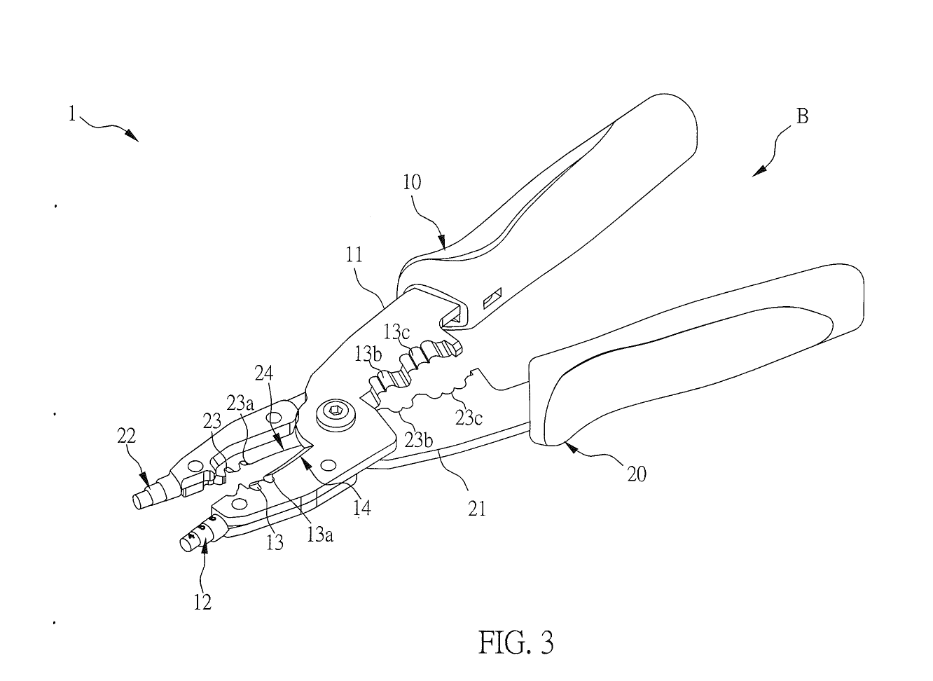

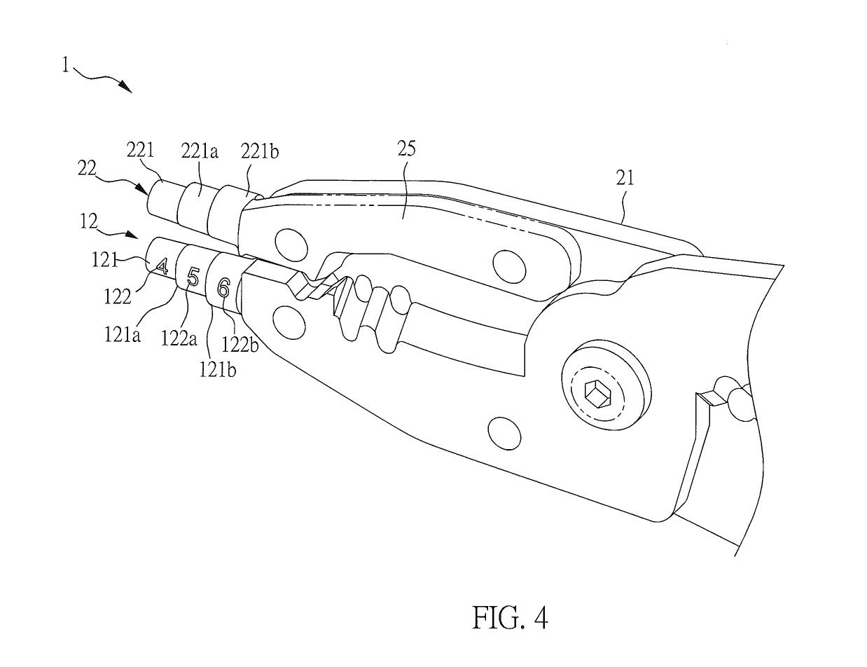

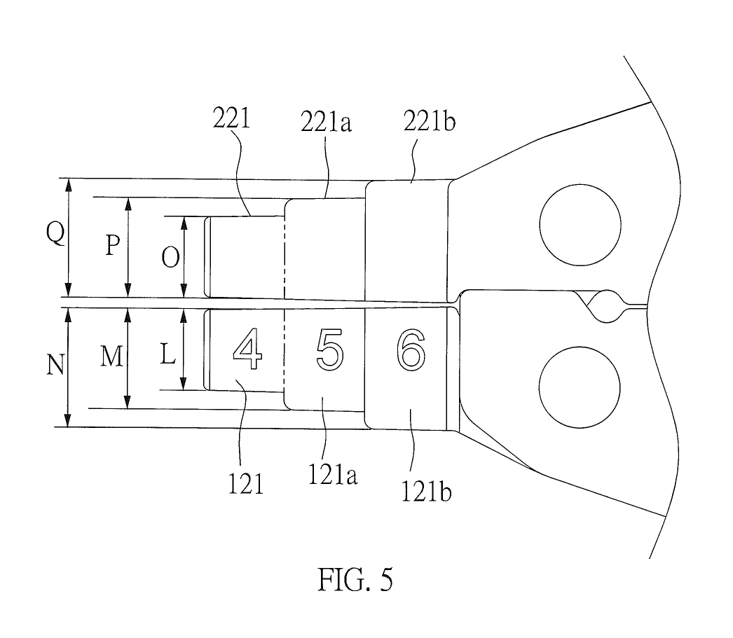

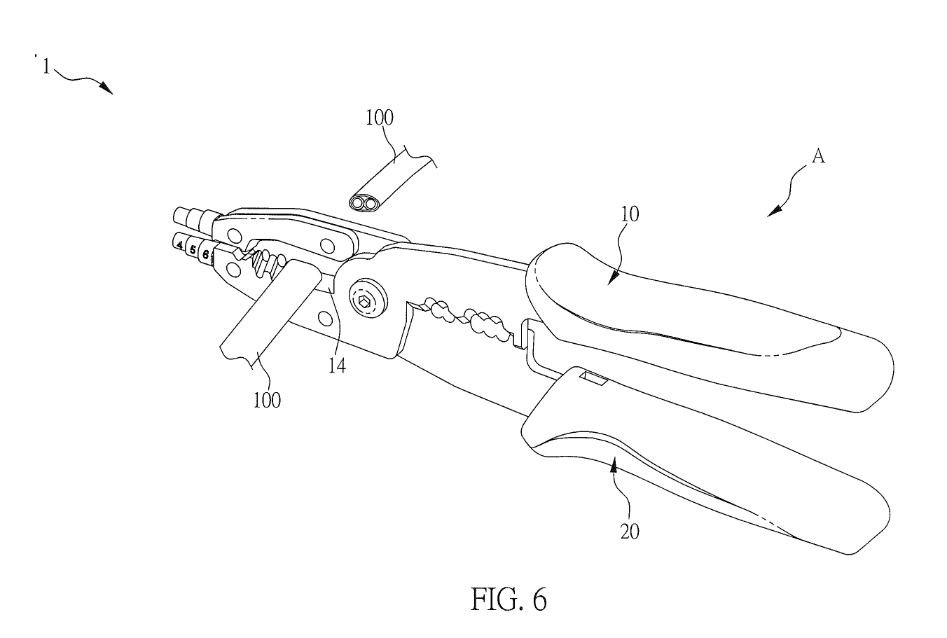

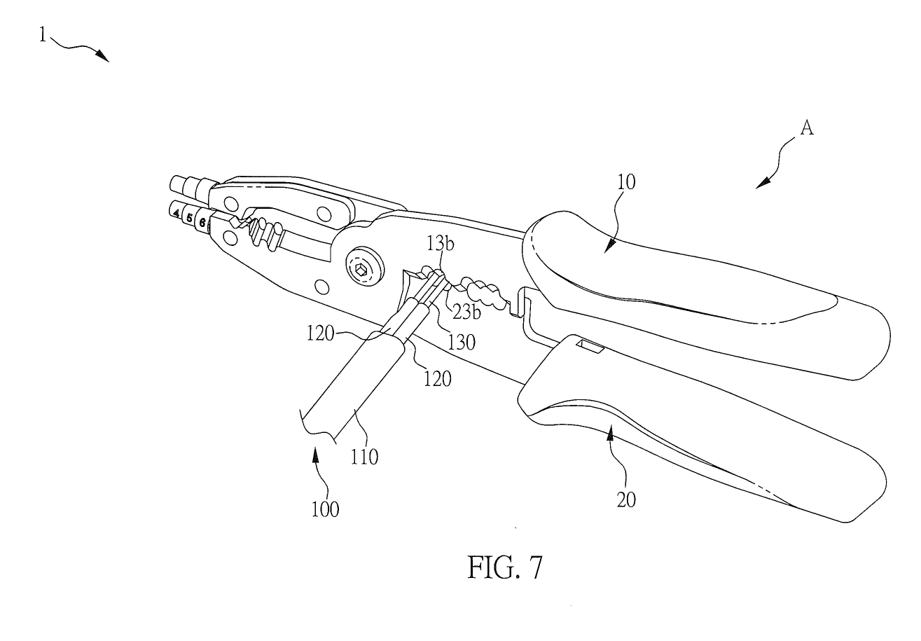

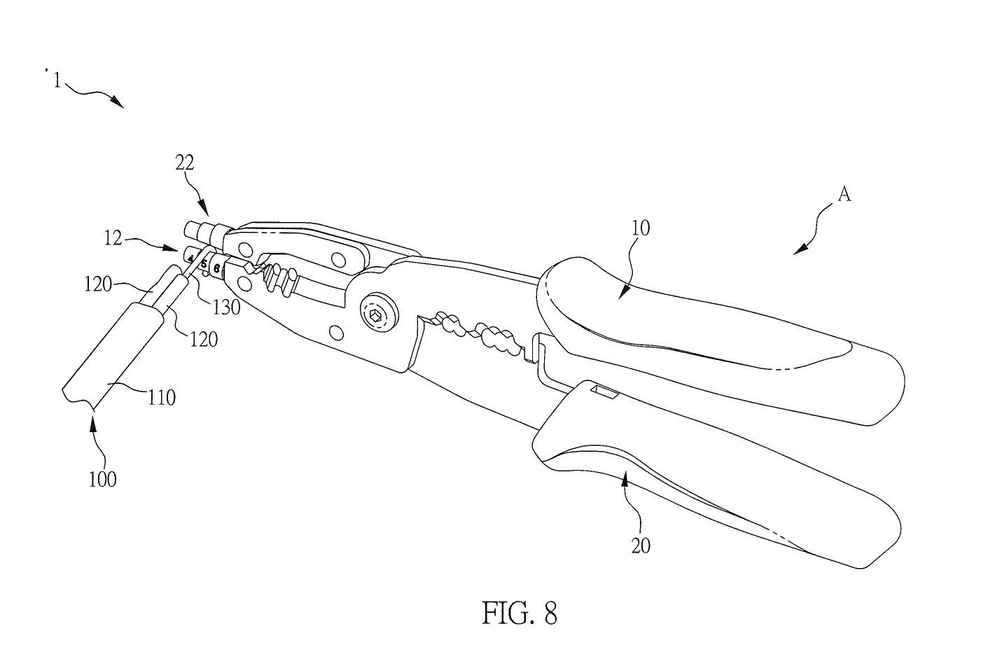

Please refer to FIG. 1 to FIG. 8 about the wire treatment pliers set in the first embodiment of the present invention. FIG. 1 illustrates an exploded perspective view of the wire treatment pliers set in the first embodiment of the present invention. FIG. 2 illustrates a schematic drawing of the wire treatment pliers set in a closed state in the first embodiment of the present invention. FIG. 3 illustrates a schematic drawing of the wire treatment pliers set in an open state in the first embodiment of the present invention. FIG. 4 illustrates a partial schematic drawing of the wire treatment pliers set in the first embodiment of the present invention. FIG. 5 illustrates a schematic drawing of the first winding part and the second winding part in the first embodiment of the present invention. FIG. 6 illustrates a schematic drawing of the wire treatment pliers set of the first embodiment of the present invention cutting the wire. FIG. 7 illustrates a schematic drawing of the wire treatment pliers set of the first embodiment of the present invention stripping the insulation layer of the wire. FIG. 8 illustrates a schematic drawing of the wire treatment pliers set of the first embodiment of the present invention winding the wire.

As shown in FIG. 1, FIG. 2 and FIG. 7, in the first embodiment of the present invention, the wire treatment pliers set 1 is used for processing a wire 100. The wire 100 in the first embodiment of the present invention is a dual-core cable. The wire 100 includes an insulation layer 110, two inner layers 120, and two cores 130. The insulation layer 110 covers the inner layers 120, and the two inner layers 120 respectively cover the two cores 130; therefore, the inner layers 120 can protect the cores 130, and the insulation layer 110 can protect the inner layers 120 and the cores 130. However, the type of the wire 100 is not limited to the dual-core cable; it can also be a triple-core cable or a single-core cable, and the structure of the wire 100 is not limited to the abovementioned description; for example, the amounts of the inner layers 120 and the cores 130 can be changed according to the design requirement.

As shown in FIG. 1 to FIG. 3, in the first embodiment of the present invention, the wire treatment pliers set 1 includes a first clamp body 10 and a second clamp body 20. The first clamp body 10 is pivotally connected to the second clamp body 20. The first clamp body 10 and the second clamp body 20 are provided for being held by the user. Via the pivotal connection between the first clamp body 10 and the second clamp body 20, the first clamp body 10 can move relative to the second clamp body 20 to be in a closed state A or an open state B.

In the first embodiment of the present invention, the first clamp body 10 includes a first main body 11, a first winding part 12, four first stripping notches 13, 13a, 13b, 13c, a first blade 14, and a first fastening part 15. The first winding part 12 is used by the user to wind the core 130 of the wire 100 to twist the core 130 into a desired shape (such as a ring structure). The first winding part 12 includes three first winding cylinders 121, 121a, 121b and three marks 122, 122a, 122b. As shown in FIG. 5, each of the first winding cylinders 121, 121a, 121b respectively includes a round face diameter L, M, or N. The round face diameters L, M, N of each of the first winding cylinders 121, 121a, 121b are different; the round face diameter L is less than the round face diameter M, and the round face diameter M is less than the round face diameter N. The three first winding cylinders 121, 121a, 121b are connected to each other in a decreasing order of size of the round face diameters L, M, N. The three marks 122, 122a, 122b are respectively located on the three first winding cylinders 121, 121a, 121b. The three marks 122, 122a, 122b are used for marking the sizes of the round face diameters L, M, N of each of the first winding cylinders 121, 121a, 121b, allowing the user to choose the first winding cylinder 121, 121a, 121b with the suitable size according to the winding size requirement of the user. In the first embodiment, the mark 122 represents that the round face diameter L of the first winding cylinder 121 is 4 mm, the mark 122a represents that the round face diameter M of the first winding cylinder 121a is 5 mm, and the mark 122b represent that the round face diameter N of the first winding cylinder 121b is 6 mm. However, the amounts of the first winding cylinders 121, 121a, 121b and the marks 122, 122a, 122b are not limited to the abovementioned description; the amounts can be changed according to the design requirement, and the numbers marked by the marks 122, 122a, 122b can also be changed according to the sizes of the round face diameters L, M, N of the first winding cylinders 121, 121a, 121b.

As shown in FIG. 1 and FIG. 2, in the first embodiment of the present invention, the four first stripping notches 13, 13a, 13b, 13c are located on the first main body 11. The first stripping notches 13, 13a, 13b, 13c are used for stripping the insulation layer 110 and the inner layers 120 of the wires 100 of different specifications; for example, the first stripping notch 13 of the first embodiment is applied to a single-core cable with a wire diameter of 1.6 mm, the first stripping notch 13a is applied to a single-core cable with a wire diameter of 2.0 mm, the first stripping notch 13b is applied to a dual-core cable, and the first stripping notch 13c is applied to a triple-core cable. Each of the first stripping notches 13, 13a, 13b, 13c has a hole and a blade. The size and the shape of the hole correspond to the size of the wire 100 for each of the first stripping notches 13, 13a, 13b, 13c. The blade is used for cutting the insulation layer 110 and the inner layer 120 such that the user can strip the insulation layer 110 and the inner layer 120. However, the amount of the first stripping notches 13, 13a, 13b, 13c and the suitable specifications of the wire 100 are not limited to the abovementioned description. The first blade 14 is located on the first main body 11, and the first blade 14 is used for cutting the wire 100. The first fastening part 15 is connected to the first winding part 12 and used for fastening to the first main body 11; when the first fastening part 15 is fastened to the first main body 11, the first winding part 12 can be combined with the first main body 11 via the first fastening part 15.

As shown in FIG. 1, in the first embodiment of the present invention, the second clamp body 20 includes a second main body 21, a second winding part 22, four second stripping notches 23, 23a, 23b, 23c, a second blade 24, and a second fastening part 25. The second winding part 22 allows the user to wind the core 130 of the wire 100 so as to twist the core 130 into a required shape. The position of the second winding part 22 corresponds to the first winding part 12. The second winding part 22 includes three second winding cylinders 221, 221a, 221b, and the positions of the three second winding cylinders 221, 221a, 221b respectively correspond to the three first winding cylinders 121, 121a, 121b. As shown in FIG. 5, each of the second winding cylinders 221, 221a, 221b respectively has a round face diameter O, P, Q, and the round face diameters O, P, Q of each of the second winding cylinders 221, 221a, 221b are different. The round face diameter O is less than the round face diameter P, and the round face diameter P is less than the round face diameter Q. The three second winding cylinders 221, 221a, 221b are connected in a decreasing order of size of the round face diameters O, P, Q. However, the amount of the second winding cylinders 221, 221a, 221b is not limited to the abovementioned description; the amount can be changed according to the design requirement.

As shown in FIG. 1 and FIG. 2, in the first embodiment of the present invention, the four second stripping notches 23, 23a, 23b, 23c are located on the second main body 21, and the positions of the four second stripping notches 23, 23a, 23b, 23c respectively correspond to the four first stripping notches 13, 13a, 13b, 13c. The second stripping notches 23, 23a, 23b, 23c coordinate with the first stripping notches 13, 13a, 13b, 13c, to strip the insulation layer 110 and the inner layers 120 of wires 100 of different specifications; for example, the second stripping notch 23 of the first embodiment is applied to a single-core cable with a wire diameter of 1.6 mm, the second stripping notch 23a is applied to a single-core cable with a wire diameter of 2.0 mm, the second stripping notch 23b is applied to a dual-core cable, and the second stripping notch 23c is applied to a triple-core cable. Each of the second stripping notches 23, 23a, 23b, 23c has a hole and a blade. The size and the shape of the hole correspond to the size of the wire 100 for each of the second stripping notches 23, 23a, 23b, 23c. The blade is used for cutting the insulation layer 110 and the inner layers 120 such that the user can strip the insulation layer 110 and the inner layers 120. However, the amount of the second stripping notches 23, 23a, 23b, 23c and the suitable specifications of the wire 100 are not limited to the abovementioned description. The second blade 24 is located on the second main body 21, and the position of the first blade 14 corresponds to the second blade 24. The second blade 24 coordinates with the first blade 14 to cut the wire 100. The second fastening part 25 is connected to the second winding part 22 and fastened to the second main body 21; when the second fastening part 25 is fastened to the second main body 21, the second winding part 22 can be combined with the second main body 21 via the second fastening part 25.

When the user uses the wire treatment pliers set 1 of the first embodiment to cut the wire 100, as shown in FIG. 3 and FIG. 6, the user causes the first clamp body 10 and the second clamp body 20 of the wire treatment pliers set 1 to be in the open state B such that a space is formed between the first blade 14 and second blade 24. Then the user puts the wire 100 into the space between the first blade 14 and the second blade 24. Finally, the user applies force to the first clamp body 10 and the second clamp body 20 to move the first clamp body 10 and the second clamp body 20 such that they are in the closed state A; whereby, the first blade 14 and the second blade 24 will close to cut the wire 100.

When the user uses the wire treatment pliers set 1 of the first embodiment to strip the insulation layer 110 and the inner layer 120 of a dual-core wire 100, as shown in FIG. 3 and FIG. 7, the user causes the first clamp body 10 and the second clamp body 20 of the wire treatment pliers set 1 to be in the open state B and places the wire 100 between the first stripping notch 13b and the second stripping notch 23b, which are applied to the dual-core cable. The user then applies force to the first clamp body 10 and the second clamp body 20 to cause the first clamp body 10 and the second clamp body 20 to be in the closed state A; at this moment, the blade of the first stripping notch 13b and the blade of the second stripping notch 23b will cut the insulation layer 110 and the inner layers 120, and the core 130 will be in the hole, such that the core 130 will not be cut. The user then applies force to remove the cutting insulation layer 110 and the inner layer 120 from the core 130 to expose the core 130 to achieve the object of stripping the insulation layer 110 and the inner layer 120.

When the user uses the wire treatment pliers set 1 of the first embodiment to wind the core 130 of the wire 100, as shown in FIG. 4 and FIG. 8, the user causes the core 130 of the wire 100 to touch the first winding part 12 such that the core 130 of the wire 100 is placed between the first winding part 12 and the second winding part 22. The user then rotates the wire treatment pliers set 1 such that the first winding part 12 and the second winding part 22 push against the core 130 via the rotation force to bend the core 130 along the first winding part 12. Therefore, the object of winding the core 130 of the wire 100 can be achieved.

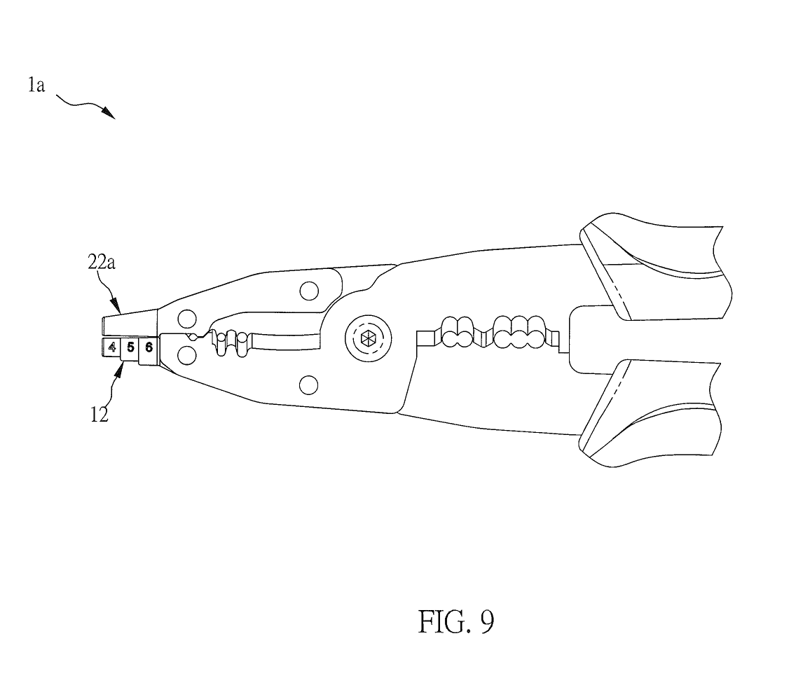

Please refer to FIG. 9 about the wire treatment pliers set in the second embodiment of the present invention. FIG. 9 illustrates a partial schematic drawing of the wire treatment pliers set in the second embodiment of the present invention.

As shown in FIG. 9, the difference between the second embodiment and the first embodiment is that, in the wire treatment pliers set 1a of the second embodiment, the second winding part 22a does not include the second winding cylinder, and the second winding part 22a is in the shape of a cone. When the user winds the wire, the user can use the cylinder structure of the first winding part 12 to wind the wire; the user can also use the cone structure of the second winding part 22a to wind the wire.

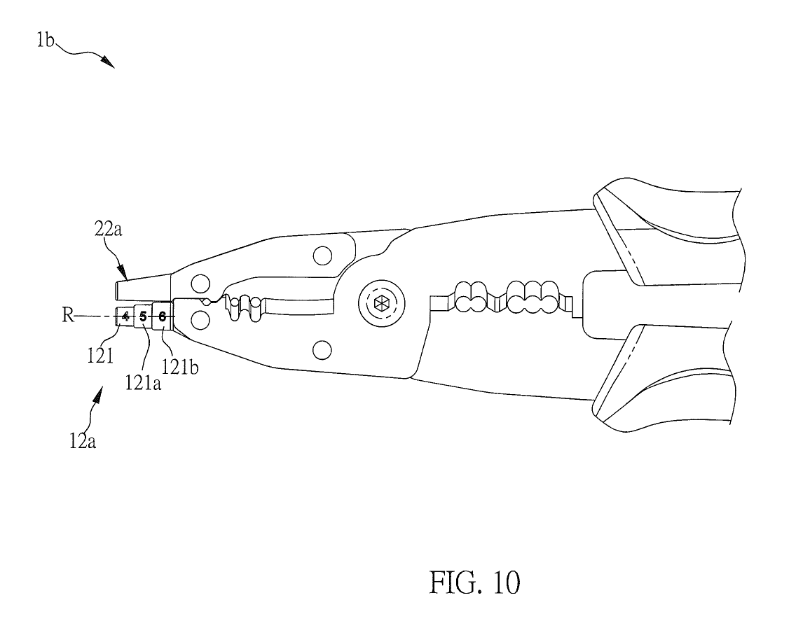

Please refer to FIG. 10 about the wire treatment pliers set in the third embodiment of the present invention. FIG. 10 illustrates a partial schematic drawing of the wire treatment pliers set in the third embodiment of the present invention.

As shown in FIG. 10, the difference between the third embodiment and the second embodiment is that, in the wire treatment pliers set 1b of the third embodiment, the three centers of the first winding cylinders 121, 121a, 121b of the first winding part 12a are located on a same axis R, such that the first winding part 12a presents a symmetrical and beautiful appearance.

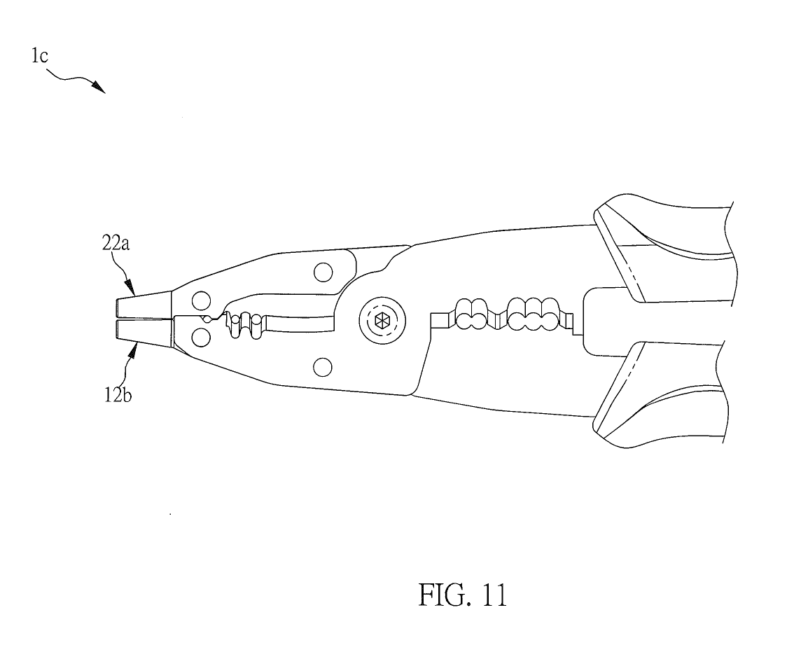

Please refer to FIG. 11 about the wire treatment pliers set in the third embodiment of the present invention. FIG. 11 illustrates a partial schematic drawing of the wire treatment pliers set in the fourth embodiment of the present invention.

As shown in FIG. 11, the difference between the fourth embodiment and the third embodiment is that, in the wire treatment pliers set 1c of the fourth embodiment, the first winding part 12b and the second winding part 22a are both in the shape of a cone. Therefore, the peaks of the cones of the first winding part 12b and the second winding part 22a can be used for winding the wire to form a ring structure of a smaller size.

Via the design of the wire treatment pliers set of the present invention, the wire treatment pliers set has the function of cutting the wire, stripping the insulation layer and the inner layer of the wire, and winding the wire. Therefore, when the user wants to cut, strip or wind the wire, the user needs to prepare only one wire treatment pliers set of the present invention; then the user can execute the abovementioned processes conveniently.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A wire treatment pliers set, comprising:
a first clamp body, comprising:
a first main body;
a first winding part; and
at least one first stripping notch, located on the first main body; and
a second clamp body, pivotally connected to the first clamp body, the second clamp body comprising:
a second main body;
a second winding part, wherein a position of the second winding part corresponds to the first winding part; and
at least one second stripping notch, located on the second main body, wherein a position of the at least one second stripping notch corresponds to the at least one first stripping notch.

2. The wire treatment pliers set as claimed in claim 1, wherein the first clamp body further comprises a first blade, and the first blade is located on the first main body; the second clamp body further comprises a second blade, and the second blade is located on the second main body; a position of the first blade corresponds to the second blade.

3. The wire treatment pliers set as claimed in claim 1, wherein the first winding part further comprises a plurality of first winding cylinders, each of the plurality of first winding cylinders respectively comprising a round face diameter; the round face diameters of each of the plurality of first winding cylinders are different, and any two of the plurality of first winding cylinders are connected to each other in a decreasing order of size of the round face diameter.

4. The wire treatment pliers set as claimed in claim 3, wherein the first winding part further comprises a plurality of marks, the plurality of marks being respectively located on the plurality of first winding cylinders.

5. The wire treatment pliers set as claimed in claim 4, wherein the centers of each of the plurality of first winding cylinders are on a same axis.

6. The wire treatment pliers set as claimed in claim 4, wherein the second winding part is in the shape of a cone.

7. The wire treatment pliers set as claimed in claim 5, wherein the second winding part is in the shape of a cone.

8. The wire treatment pliers set as claimed in claim 4, wherein the second winding part further comprises a plurality of second winding cylinders, each of the plurality of second winding cylinders respectively comprising a round face diameter; the round face diameters of each of the plurality of second winding cylinders are different, and any two of the plurality of the second winding cylinders are connected to each other in a decreasing order of size of the round face diameter.

9. The wire treatment pliers set as claimed in claim 1, wherein the first winding part and the second winding part are respectively in the shape of a cone.

10. The wire treatment pliers set as claimed in claim 1, wherein the first clamp body further comprises a first fastening part; the first fastening part is connected to the first winding part and fastened to the first main body; the second clamp body further comprises a second fastening part; the second fastening part is connected to the second winding part and fastened to the second main body.
